(19) United States
(12) Patent Application Publication
(10) Pub. No.: US 2015/0239198 A1
(43) Pub. Date: Aug. 27, 2015

(54) ATTACHING STRUCTURE OF INSERT MEMBER TO BLOW MOLDED ARTICLE

(71) Applicant: FTS CO., LTD., Toyota (JP)

(72) Inventors: Hideki Iwata, Toyota (JP); Eiji Yonemochi, Toyota (JP); Koji Sugiura, Toyota (JP); Katsuhiro Kajikawa, Toyota (JP)

(73) Assignee: FTS CO., LTD., Toyota (JP)

(21) Appl. No.: 14/191,221

(22) Filed: Feb. 26, 2014

(51) Int. Cl. B32B 1/08; F16L 23/12; B32B 3/26

(52) U.S. Cl. CPC B32B 1/08; B32B 3/266; F16L 23/12; B32B 2597/00

(57) ABSTRACT

An attaching structure for attaching an insert member to an outer wall of a blow molded article by embedding the insert member therein, which is readily produced and exhibits a great holding strength against the insert member. In an attaching structure of an insert member for attaching the insert member to an outer wall of a blow molded article by embedding at least one part of the insert member therein, the insert member includes a cylinder part adapted to penetrate the outer wall of the blow molded article, and a flange part protruding from an exterior surface of the cylinder part in a width direction thereof. The flange part is embedded in the outer wall of the blow molded article and includes a plurality of through holes adapted to flow a parison into the plurality of through holes during blow molding, thereby fusion-bonding both surfaces of the flange part with the parison, and after the parison is hardened, a flange cover part is integrally formed with an outer wall of the insert member to hold the flange part.

### CROSS-REFERENCE TO RELATED APPLICATIONS

This application is related to and claims priority from Japanese patent applications Nos. 2012-187345 and 2012-194298 incorporated herein by reference.

### BACKGROUND OF THE INVENTION

1. Field of the Invention

The present invention relates to a structure for attaching an insert member by embedding at least one portion of the insert member in an outer wall of a blow molded article, which can be particularly applied to an insert member for attaching the same to an automobile fuel tank formed by blow molding.

2. Description of Related Art

A filler tube for injecting fuel into an automobile fuel tank is attached thereto. Conventionally, such an automobile fuel tank has been made of metals, but, recently, a fuel tank made of a thermoplastic synthetic resin has been also used, because it can effect lightweight vehicle bodies, no rust is generated therein, and it can be readily formed into a desired configuration.

And, a fuel tank as a blow molded article formed by blow molding has been used, because it can be readily produced. As shown in FIG. 1, in a fuel tank 10 as a blow molded article made of a thermoplastic synthetic resin, a tube attaching member 12 adapted to attach various tubes and pipes for injecting or exhausting liquid or gas into or from the fuel tank 10, along with various hoses and cables is attached to an outer wall of the fuel tank 10.

In one conventional example, as shown in FIG. 2, a tube attaching member 14 is welded to an outer wall of a fuel tank 16 made of a thermoplastic synthetic resin as a blow molded article formed by blow molding (See Japanese Unexamined Patent Application Publication No. 2003-236920, for example.). This tube attaching member 14 has a welding seat 18, and the welding seat 18 is welded to an outer wall 20 of the fuel tank 16. The welding seat 18 has an air release hole 22 adapted to release air interposed between a parison and the welding seat 18 during blow molding.

With this structure, a welding surface of the welding seat 18 is flat so that sufficient welding of the welding seat 18 is not effected without preheating the welding surface of the tube attaching member 14 to elevated temperatures. And, a welding margin is thin so that it is difficult to obtain a sufficient welding strength of the welding seat 18 against loads in drawing, bending, and rotating directions, which are applied from an exterior side of the fuel tank 16 to the tube attaching member 14. In addition, the tube attaching member 14 is welded to the fuel tank 16 merely with the welding surface of the welding seat 18 so that it is difficult to obtain a sufficient welding strength against loads in bending and rotating directions.

### SUMMARY OF THE INVENTION

Accordingly, it is an object of the present invention to provide an attaching structure of an insert member to an outer wall of a blow molded article by embedding the insert member therein, which is readily produced and exhibits a great holding strength against the insert member.

According to a first aspect of the present invention, in an attaching structure of an insert member for attaching the insert member to an outer wall of a blow molded article by embedding at least one part of the insert member therein, the insert member includes a cylinder part adapted to penetrate the outer wall of the blow molded article, and a flange part protruding from an exterior surface of the cylinder part in a width direction thereof, the flange part is embedded in the outer wall of the blow molded article, and includes a plurality of through holes, a parison is flowed into the plurality of through holes during blow molding to fusion-bond both surfaces of the flange part with the parison such that the parison is hardened to define a flange cover part integrally formed with an outer wall of the insert member, thereby holding the flange part.

In the first aspect of the present invention, in an attaching structure of an insert member for attaching the insert member to an outer wall of a blow molded article by embedding at least one part of the insert member therein, the insert member includes a cylinder part adapted to penetrate the outer wall of the blow molded article, and a flange part protruding from an exterior surface of the cylinder part in a width direction thereof. Therefore, by embedding the flange part in the outer wall of the blow molded article, the cylinder part is attached to the blow molded article to define an opening of the blow molded article. Liquid or gas can be injected into or discharged from the blow molded article by way of the opening.

The flange part is embedded in the outer wall of the blow molded article, and includes a plurality of through holes, a parison is flowed into the plurality of through holes during blow molding to fusion-bond both surfaces of the flange part with the parison such that the parison is hardened to define a flange cover part integrally formed with the outer wall of the insert member, thereby holding the flange part. Therefore, the parison flowed into the plurality of through holes can hold both surfaces of the flange part strongly, and both surfaces of the flange part are fusion-bonded with the parison during blow molding to hold the flange part. Consequently, the fusion-bonding area between the flange part and the flange cover part becomes large to increase the fusion-bonding strength. In addition, after the parison is hardened, the flange part is embedded in the outer wall of the blow molded article, and is held with the flange cover part integrally formed with the outer wall of the blow molded article so that the flange part can be strongly held furthermore. Therefore, if loads in drawing, bending, and rotating directions are applied to the cylinder part, the insert member can be securely held.

According to a second aspect of the present invention, the plurality of through holes are provided in the flange part at equal intervals circumferentially.

In the second aspect of the present invention, the plurality of through holes are provided in the flange part at equal intervals circumferentially so that the parison homogeneously fills around the flange part entirely, and after the parison is hardened, the flange cover part can securely and strongly hold the flange part over the entire circumference thereof.

According to a third aspect of the present invention, the plurality of through holes are formed to have an elliptical or circular shape.

In the third aspect of the present invention, the plurality of through holes are formed to have an elliptical or circular shape so that the parison can flow into the plurality of through holes smoothly. In the case of an elliptical shape, the amount of the parison flowing into the through holes is large so that the exterior surface and the interior surface of the flange part can be strongly held with the flange cover part defined with the hardened parison. In the case of a circular shape, many holes can be formed along a periphery of the flange part so that the flange part can be held uniformly.

According to a fourth aspect of the present invention, the cylinder part of the insert member includes an outside cylinder part projecting outside the blow molded article, and an inside cylinder part projecting inside the blow molded article, and an inside cylinder cover part is fusion-bonded to an exterior surface of the inside cylinder part.

In the fourth aspect of the present invention, the cylinder part of the insert member includes an outside cylinder part projecting outside the blow molded article, and an inside cylinder part projecting inside the blow molded article, and an inside cylinder cover part is fusion-bonded to an exterior surface of the inside cylinder part. Therefore, the parison is fusion-bonded to the insert member in not only the flange part but also the inside cylinder part so that the holding strength against the insert member increases, and consequently, if loads in drawing, bending, and rotating directions are applied to the outside cylinder part, the insert member can be securely held.

According to a fifth aspect of the present invention, protruding linear parts are provided in the flange part or the inside cylinder part, and at least a tip end of the protruding linear part is fusion-bonded to the flange cover part or the inside cylinder cover part.

In the fifth aspect of the present invention, protruding linear parts are provided in the flange part or the inside cylinder part, and at least a tip end of the protruding linear part is fusion-bonded to the flange cover part or the inside cylinder cover part. The tip end of the protruding linear part is readily heated with the parison and readily melted so as to be fusion-bonded to the parison. After the parison is hardened, the tip end of the protruding linear part bites in the flange cover part or the inside cylinder cover part and is fixed thereto, thereby improving the sealing properties. In addition, the protruding linear part is readily heated so that the temperature for preheating the entire body of the insert member can be lowered, or the preheating process can be omitted, whereby the deformation of the insert member due to the lowering of the rigidity can be prevented.

According to a sixth aspect of the present invention, the protruding linear parts include a plurality of protruding linear parts formed in an interior surface of the flange part circumferentially, and at least a tip end of each protruding linear part is fusion-bonded to the flange cover part.

In the sixth aspect of the present invention, the protruding linear parts include a plurality of protruding linear parts formed in an interior surface of the flange part circumferentially, and at least a tip end of each protruding linear part is fusion-bonded to the flange cover part so that the protruding linear parts in the interior surface of the flange part are melted with the parison and bite thereinto, and after the parison is solidified, the flange cover part and the protruding linear parts in the interior surface of the flange part are welded to each other, thereby improving the sealing properties against the outer wall of the blow molded article.

According to a seventh aspect of the present invention, the protruding linear parts include a plurality of protruding linear parts formed in an exterior surface of the inside cylinder part circumferentially, and at least a tip end of each protruding linear part is fusion-bonded to the inside cylinder cover part.

In the seventh aspect of the present invention, the protruding linear parts include a plurality of protruding linear parts formed in an exterior surface of the inside cylinder part circumferentially, and at least a tip end of each protruding linear part is fusion-bonded to the inside cylinder cover part. In the case where the protruding linear parts are formed in the exterior surface of the inside cylinder part circumferentially, the protruding linear parts are melted with the parison to be welded thereto, and after the parison is hardened, the sealing properties between the inside cylinder cover part and the exterior surface of the inside cylinder part are improved.

According to an eighth aspect of the present invention, the protruding linear part is formed in a tip end surface of the inside cylinder part circumferentially, and at least a tip end of each protruding linear part is fusion-bonded to a cover end part extending from the inside cylinder cover part integrally therewith and adapted to cover the tip end surface of the inside cylinder part.

In the eighth aspect of the present invention, the protruding linear part is formed in a tip end surface of the inside cylinder part circumferentially, and at least a tip end of each protruding linear part is fusion-bonded to a cover end part extending from the inside cylinder cover part integrally therewith and adapted to cover the tip end surface of the inside cylinder part. Where the protruding linear part is formed in a tip end surface of the inside cylinder part circumferentially, the protruding linear part is melted with the parison and is fusion-bonded thereto, and after the parison is hardened, the cover end part extending from the inside cylinder cover part integrally therewith and adapted to cover the tip end surface of the inside cylinder part is fixed to the tip end of the protruding linear part to improve the sealing properties against the tip end surface of the inside cylinder part.

According to a ninth aspect of the present invention, the tip end of the protruding linear part has a triangular sectional shape, a trapezoidal sectional shape, a circular sectional shape, or an elliptical sectional shape.

In the ninth aspect of the present invention, the tip end of the protruding linear part has a triangular sectional shape, a trapezoidal sectional shape, a circular sectional shape, or an elliptical sectional shape. Where the tip end of the protruding linear part has a triangular sectional shape, the triangular tip end is readily melted with the parison so that the protruding linear part is securely fusion-bonded to the parison. Where the tip end of the protruding linear part has a trapezoidal sectional shape, the trapezoidal tip end is readily melted with the parison so that the fusion-bonding area between the protruding linear part and the parison increases, whereby the protruding linear part is strongly fusion-bonded to the parison. Where the tip end of the protruding linear part has a circular or elliptical sectional shape, the circular or elliptical tip end is melted with the parison so that an arc-shaped region of the protruding linear part, which is adapted to be fusion-bonded to the parison, enters the parison, whereby the protruding linear part is strongly fusion-bonded to the parison.

According to a tenth aspect of the present invention, the insert member has a recessed part adapted to be charged with a parison on an exterior side of the flange part.

In the tenth aspect of the present invention, the insert member has a recessed part adapted to be charged with a parison on an exterior side of the flange part so that the parison can securely enter around a base of the flange part, and an end of the parison entering the exterior side of the flange part can be held with the recessed part to securely and strongly hold the flange part.

According to an eleventh aspect of the present invention, the blow molded article is an automobile fuel tank, and the insert member is a tube attaching member for attaching a tube adapted to inject and discharge liquid or gas into and from the automobile fuel tank, to the automobile fuel tank.

In the eleventh aspect of the present invention, the blow molded article is an automobile fuel tank, and the insert member is a tube attaching member for attaching a tube adapted to inject and discharge liquid or gas into and from the automobile fuel tank, to the automobile fuel tank. With this arrangement, the tube attaching member exhibits an improved strength to securely hold the tube, the sealing properties between the automobile fuel tank and the tube attaching member are improved to prevent the leakage of fuel and fuel vapor.

The flange part is embedded in the outer wall of the blow molded article, and includes a plurality of through holes, a parison is flowed into the plurality of through holes during blow molding to fusion-bond both surfaces of the flange part with the parison such that after the parison is hardened, a flange cover part is integrally formed with the outer wall of the insert member to hold the flange part. Therefore, the parison flowed into the plurality of through holes can strongly hold the flange part, and both surfaces of the flange part are fusion-bonded and held with the flange cover part so that the fusion-bonding area between the flange part and the flange cover part enlarges to increase the fusion-bonding strength. Since the flange part is held with the flange cover part formed using the hardened parison, if a drawing load is applied to the cylinder part, or loads are applied from the outside of the blow molded article in bending and rotation directions, the insert member can be securely held.

Other objects, features, and characteristics of the present invention will become apparent upon consideration of the following description and the appended claims with reference to the accompanying drawings, all of which form a part of this specification.

### BRIEF DESCRIPTION OF THE DRAWINGS

FIG. 1 is a sectional view of a fuel tank;

FIG. 2 is a sectional view of an attaching portion of a tube attaching member to a conventional fuel tank;

FIG. 3 is a sectional view of a first embodiment of an automobile fuel tank in accordance with the present invention, which shows an attaching portion of a tube attaching member to the fuel tank, taken along line A-A of FIG. 4;

FIG. 4 is a plan view of the tube attaching member of the first embodiment of the fuel tank;

FIG. 5 is a sectional view of a second embodiment of an automobile fuel tank in accordance with the present invention, which shows an attaching portion of a tube attaching member to the fuel tank, taken along line B-B of FIG. 6;

FIG. 6 is a plan view of the tube attaching member of the second embodiment of the fuel tank;

FIG. 7 is a plan view of a tube attaching member of a third embodiment of an automobile fuel tank in accordance with the present invention;

FIG. 8 is a plan view of a tube attaching member of a fourth embodiment of an automobile fuel tank in accordance with the present invention;

FIG. 9 is an enlarged sectional view of a flange part of a tube attaching member of a fifth embodiment of an automobile fuel tank in accordance with the present invention;

FIG. 10 is an enlarged sectional view of a protruding linear part formed in the flange part of the tube attaching member of the fifth embodiment of the automobile fuel tank;

FIG. 11 is an enlarged sectional view of another protruding linear part formed in the flange part of the tube attaching member of the fifth embodiment of the automobile fuel tank;

FIG. 12 is an enlarged sectional view of another protruding linear part formed in the flange part of the tube attaching member of the fifth embodiment of the automobile fuel tank;

FIG. 13 is an enlarged sectional view of a further protruding linear part formed in the flange part of the tube attaching member of the fifth embodiment of the automobile fuel tank;

FIG. 14 is a sectional view of a sixth embodiment of an automobile fuel tank in accordance with the present invention, which shows an attaching portion of a tube attaching member to the fuel tank, taken along line A-A of FIG. 4;

FIG. 15 is an enlarged sectional view of a flange part and a tank inside cylinder part of a tube attaching member of the sixth embodiment of the automobile fuel tank;

FIG. 16 is a sectional view of a seventh embodiment of an automobile fuel tank in accordance with the present invention, which shows an attaching portion of a tube attaching member to the fuel tank, taken along line A-A of FIG. 4;

FIG. 17 is an enlarged sectional view of a tip end of a tank inside cylinder part of a tube attaching member of the seventh embodiment of an automobile fuel tank;

FIG. 18 shows a process of attaching a tube attaching member to an automobile fuel tank in accordance with the present invention, and is a partially sectioned view of a blow mold in a state where the tube attaching member is attached to the blow mold;

FIG. 19 shows a process of attaching a tube attaching member to an automobile fuel tank in accordance with the present invention, and is a partially sectioned view of a blow mold in a state where the tube attaching member is attached to the blow mold, and a parison contacts the tube attaching member;

FIG. 20 shows a process of attaching a tube attaching member to an automobile fuel tank in accordance with the present invention, and is a partially sectioned view of a blow mold in a state where the tube attaching member is attached to the blow mold, a parison contacts the tube attaching member and the parison is broken through with a blow pin; and

FIG. 21 shows a process of attaching a tube attaching member to an automobile fuel tank in accordance with the present invention, and is a partially sectioned view of a blow mold in a state where the tube attaching member is attached to the blow mold, a parison is broken through with a blow pin, and the tube attaching member is attached to the parison.

### DETAILED DESCRIPTION OF THE PREFERRED EMBODIMENTS

The present invention will be explained based on an attaching structure in which a tube attaching member is attached to an outer wall of a fuel tank, for example, but the present invention can be widely applied to the case in which an insert member is attached to any blow molded article other than the fuel tank.

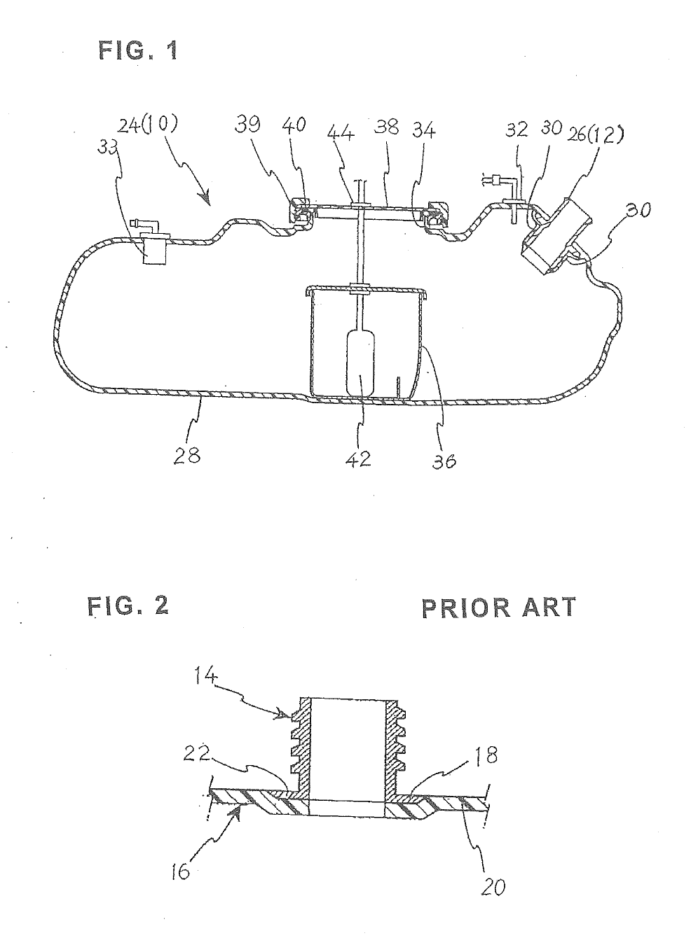

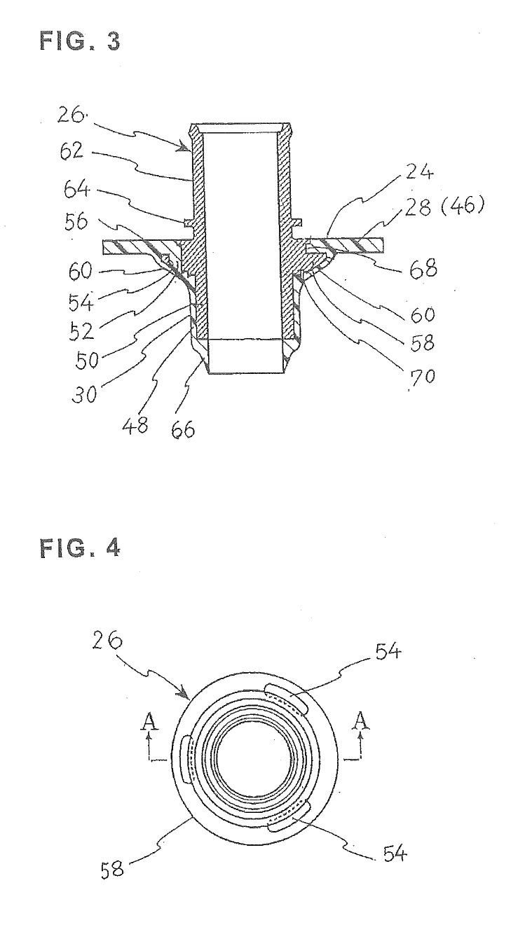

Embodiments of the present invention will be explained with reference to FIG. 1, FIG. 3 through FIG. 17.

First, a first embodiment will be explained with reference to FIGS. 1, 3 and 4.

FIG. 1 is a sectional view of a fuel tank 24 in which the first embodiment of an attaching structure of a tube attaching member 26 is used. FIG. 3 is a sectional view of the first embodiment of the attaching structure in which the tube attaching member 26 as an insert member is attached to the outer wall 28 of the fuel tank 24 as a blow molded article.

As shown in FIG. 1, the fuel tank 24 is formed by blow molding, and the outer wall 28 is formed integrally. The outer wall 28 can be composed of a single layer of a thermoplastic synthetic resin, or a plurality of layers thereof.

In the case of a plurality of layers, layers having high rigidity and layers having low fuel permeability can be combined with each other.

In the case of a plurality of layers, for example, a center layer is composed of a fuel permeation preventing barrier layer of an ethylene vinyl alcohol copolymer (EVOH) or nylon, adhesive layers of modified polyethylene are formed on upper and lower sides of the barrier layer, and outer layers of a high density polyethylene (HDPE) are formed on exterior sides of the adhesive layers.

In the upper portion of the outer wall 28, the tube attaching member 26 and a tank attaching portion 30 adapted to attach the tube attaching member 26 shown in FIG. 3 are provided. The tube attaching member 26 is adapted to attach a filler tube for injecting fuel into the fuel tank 24 and a fuel pipe for supplying fuel to an engine from the fuel tank 24.

In addition, in the upper portion of the outer wall 28, a breather port attaching portion 32 is provided. The breather port attaching portion 32 is adapted to attach a breather hose (not shown) for releasing a gas from an interior of the fuel tank 24 to an exterior thereof during fuel supply. And reference numeral 33 designates a cut off valve adapted to prevent fuel leakage from the fuel tank 24 when an automobile overturns.

In an upper surface of the outer wall 28, hose clamps adapted to hold various hoses such as a fuel transfer hose may be provided. The present invention can be applied to these breather port attaching portion 32 and pipe and hose attaching members such as hose clamps, etc., similarly to the tube attaching member 26.

In the upper surface of the outer wall 28, an opening 34 is further provided, and a sub-tank 36 is attached on an inner surface of a lower portion of the outer wall 28 from the opening 34. The opening 34 is closed with a lid 38, and the lid 38 is screwed around the opening 34 with a lock plate 39. A seal ring 40 is attached between the opening 34 and the lid 38 to provide a seal therebetween.

And a fuel pump unit 42 is attached in an interior of the sub-tank 36. The sub-tank 36 is provided such that the fuel pump unit 42 can securely feed fuel from the fuel tank 24 to an engine when a vehicle is inclined or vibrated. The fuel pump unit 42 is attached to the lid 38 for performing repair and maintenance. A pipe extends from the fuel pump unit 42 and is connected to a fuel main port attaching portion 44 provided in the lid 38 in the upper portion of the outer wall 28. A fuel pipe (not shown) adapted to transfer fuel to the engine is attached to the fuel main port attaching portion 44.

As shown in FIG. 3, the tank attaching portion 30 is provided in the upper portion of the outer wall 28 of the fuel tank 24. The tank attaching portion 30 is formed in the outer wall 28 of the fuel tank 24, to which the later-described tube attaching member 26 is attached, when the fuel tank 24 is formed by blow molding. As described later, the tank attaching portion 30 is formed by hardening of a parison 46 to define an inside cylinder cover part 48 welded to an inside cylinder part 50 of the tube attaching member 26, a flange hole charging part 52 welded to a flange hole 54, and a flange cover part, and the flange cover part includes a flange cover upper part 56 welded to an exterior surface of a flange part 58, and a flange cover lower part 60 welded to an interior surface of the flange part 58.

Next, the tube attaching member 26 in the first embodiment will be explained with reference to FIG. 3 and FIG. 4.

The tube attaching member 26 is formed by injection molding separately from the fuel tank 24. The material thereof is composed of a fuel oil-resistant thermoplastic synthetic resin. A synthetic resin such as polyethylene, polypropylene, polyacetal, polyamide, etc. can be used, for example, but such a material as to be weldable to the parison 46 used upon blow molding.

The tube attaching member 26 as an insert member includes a cylinder part adapted to penetrate the outer wall 28 of the fuel tank 24, and the flange part 58 protruding from an exterior surface of the cylinder part in the width direction thereof. The cylinder part includes an outside cylinder part 62 projecting from the outer wall 28 outwardly, and the inside cylinder part 50 projecting from the outer wall 28 inwardly. A protruding linear part 64 is formed in an outer periphery of the outside cylinder part 62 close to the flange part 58. When a tube is inserted in the outside cylinder part 62, the protruding linear part 64 acts as a stopper for a tip end of the inserted tube to hold the same.

When the blow molding is performed, the parison 46 adapted to form the outer wall 28 is fusion-bonded to an exterior surface of the inside cylinder part 50, and after the parison 46 is hardened, it defines the inside cylinder cover part 48. With this arrangement, the parison 46 is fusion-bonded to not only the flange part 58 of the tube attaching member 26 but also the inside cylinder part 50 thereof so that the tube attaching member 26 has a great holding strength, whereby if a drawing load, and loads in bending and rotating directions, etc. are applied from an exterior side of the outside cylinder part 62, it can securely hold the tube attaching member 26.

After the parison 46 is hardened, the inside cylinder cover part 48 is formed on the exterior surface of the inside cylinder part 50 so as to be welded thereto. The parison 46 is fusion-bonded to a tip end of the inside cylinder cover part 48 to define a cover end part 66 so as to cover a tip end of the inside cylinder part 50 continuously with the inside cylinder cover part 48. With this arrangement, the sealing properties between the outer wall 28 and the tube attaching member 26 are improved by virtue of the fusion-bonding of the tip end of the inside cylinder part 50 and the parison 46.

The flange part 58 is formed to protrude outwardly from the vicinity of a border between the outside cylinder part 62 and the inside cylinder part 50 into a disk-shaped configuration.

As shown in FIG. 4, the flange part 58 has a plurality of flange holes 54 at equal intervals along a periphery thereof. In the first embodiment, three flange holes 54, each having a elliptic shape, are formed. When the blow molding is performed, the parison 46 is made to flow in the flange holes 54 to fusion-bond both side surfaces of the flange part 58 with the parison 46, and after the parison 46 is hardened, the parison 46 acts as the flange hole charging part 52 and is fusion-bonded to the outer wall 28.

Therefore, the parison 46 flowed into the flange holes 54 can cover both surfaces of the flange part 58, and the parison 46 covering both surfaces thereof is joined with the parison 46 existing in the flange holes 54 so that the flange part 58 can be strongly held, and since the both surfaces of the flange part 58 are fusion-bonded to the parison 46, the fusion-bonding area between the flange part 58 and the parison 46 is enlarged to increase the fusion-bonding strength between the outer wall 28 and the parison 46.

After the parison 46 is hardened furthermore, an exterior side of the flange part 58 can be covered with the flange cover upper part 56, whereas an interior side of the flange part 58 can be covered with the flange cover lower part 60 so that the flange part 58 is embedded inside the outer wall 28 of the fuel tank 24, whereby the flange part 58 is entirely held with the tank attaching portion 30 to further hold the flange part 58 strongly. Therefore, if a drawing load, and loads in bending and rotating directions, etc. are applied from the exterior side of the outside cylinder part 62, the tube attaching member 26 can be securely held.

A recessed part 68 into which the parison 46 is adapted to flow can be formed on the exterior side of the flange part 58 in the vicinity of a base thereof so as to extend circumferentially. With this arrangement, the parison 46 can be securely made to flow into the recessed part 68 provided at the base of the flange part 58 during blow molding. Therefore a tip end of the parison 46 flowing along an exterior surface of the flange part 58 and entering into the recessed part 68 can be held with the recessed part 68, whereby the base of the flange part 58 can be securely held with the outer wall 28 strongly.

A plurality of protruding linear parts 70 can be formed on an interior surface of the flange part 58. With this arrangement, the protruding linear parts 70 provided on the interior surface of the flange part 58 bite into the parison 46 during blow molding to strongly fix the interior surface of the flange part 58 and the flange cover lower part 60, thereby improving the sealing properties between the interior surface of the flange part 58 and the outer wall 28. As a result, a fuel vapor, etc. do not leak between the tube attaching member 26 and the outer wall 28. Alternatively, a single protruding linear part 70 will do.

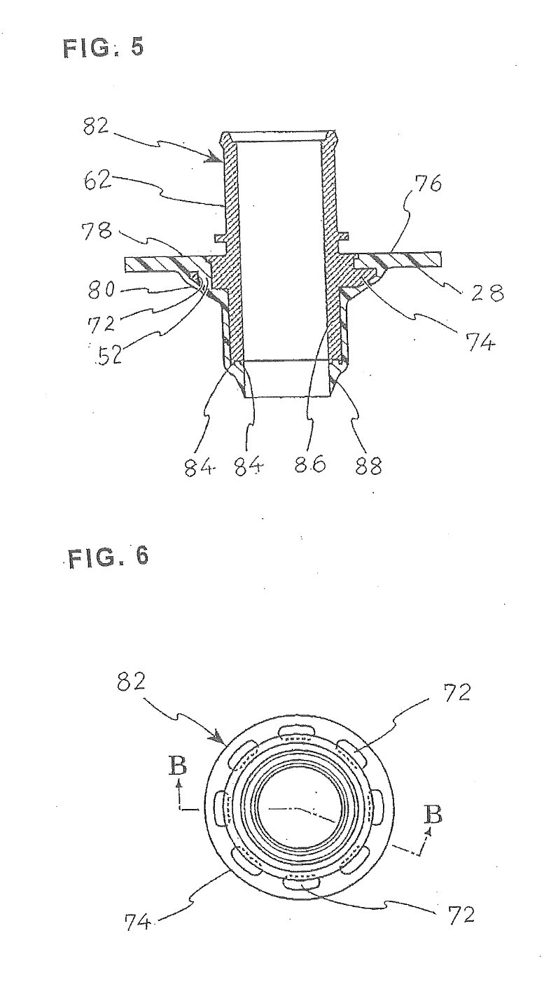

Next, a second embodiment will be explained with reference to FIG. 5 and FIG. 6. The second embodiment differs form the first embodiment in the configuration of the flange part and that of a tip end of a tank inside cylinder part, but the remaining portions of the second embodiment are similar to those of the first embodiment. Therefore, only different portions will be explained while omitting explanations of similar portions.

In the second embodiment, flange holes 72 of a flange part 74 include eight elliptical holes extending circumferentially. A parison 76 existing on both surfaces of the flange part 74 is strongly joined to a flange cover upper part 78 and a flange cover lower part 80 of the outer wall 28 that is formed after hardening of the parison 76 by virtue of the eight flange holes 72 to strongly hold a tube attaching member 82 at eight places.

No protruding linear part is provided in the flange part 74, but since many flange holes 72 are formed, the holding force of the flange part 74 can be maintained.

As shown in FIG. 5, two protruding linear parts 84 are formed at a tip end of an inside cylinder part 86. With this arrangement, a cover end part 88 bites into the parison 76 during blow molding by virtue of the two protruding linear parts 84 so that the parison 76 is readily held with the tip end of the inside cylinder part 86, whereby the parison 76 can be welded to the tip end of the inside cylinder part 86. As a result, the tube attaching member 82 can be strongly held.

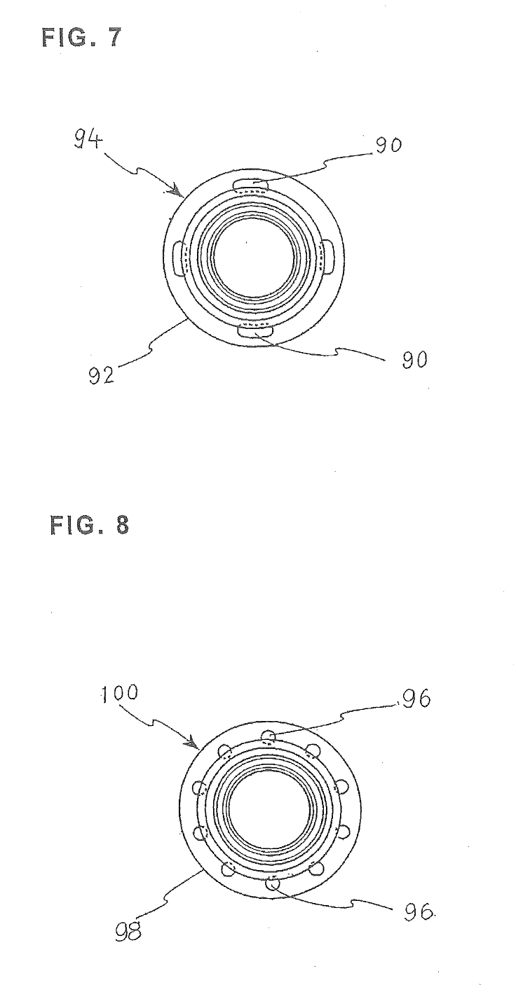

Next, third and fourth embodiments will be explained with reference to FIG. 7 and FIG. 8. The third and fourth embodiments differ form the first embodiment in the configuration of the flange holes of the flange part, but the remaining portions are similar to those of the first embodiment. Therefore, only different portions will be explained while omitting explanations of similar portions.

In the third embodiment shown in FIG. 7, flange holes 90 of a flange part 92 of a tube attaching member 94 include four elliptical holes provided circumferentially at intervals of 90 degrees. As a result, exterior and interior sides of the parison 46 are jointed to each other at four places of the flange part 92. Since the number of the flange holes 90 is four, the tube attaching member 94 can be held without lowering the strength of the flange part 92.

In the fourth embodiment shown in FIG. 8, flange holes 96 of a flange part 98 of a tube attaching member 100 include ten circular holes provided circumferentially at equal intervals. As a result, exterior and interior sides of the parison 46 are jointed to each other at ten places of the flange part 98 so that the parison 46 can hold the flange part 98 uniformly without lowering the strength thereof. Since the flange holes 96 is circular, many flange holes 96 can be formed in the circumferential direction of the flange part 98, thereby holding the flange part 98 uniformly.

The flange holes 96 may have any configuration other than circular and elliptical configurations.

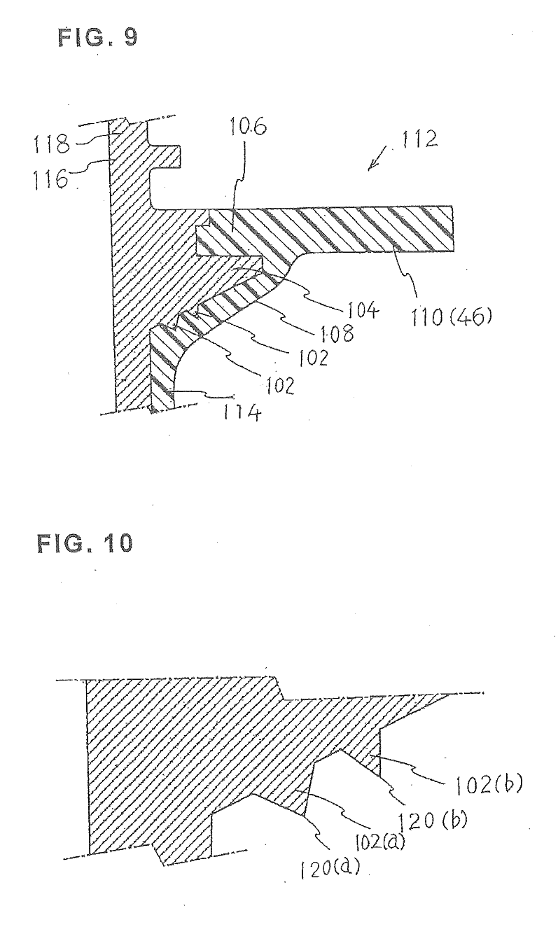

Next, fifth through seventh embodiments will be explained with reference to FIG. 9 through FIG. 17.

In the fifth embodiment, a plurality of protruding linear parts 102 are provided in an interior surface of a flange part 104. The protruding linear parts 102 contact the parison 46 during blow molding so that tip ends of the protruding linear parts 102 are melted with heat of the parison 46 to fusion-bond the protruding linear parts 102 and the parison 46 to each other.

After the parison 46 is hardened, an exterior surface of the flange part 104 can be covered with a flange cover upper part 106, whereas an interior surface of the flange part 104 can be covered with a flange cover lower part 108 so that the flange part 104 is embedded inside an outer wall 110 of a fuel tank 112, whereby the flange part 104 is entirely held with a tank attaching portion 114 to further hold the flange part 104 strongly. Therefore, if a drawing load, and loads in bending and rotating directions, etc. are applied to an outside cylinder part 116, a tube attaching member 118 can be securely held.

As a result, the interior surface of the flange part 104, and the flange cover lower part 108 are strongly fixed to each other, thereby improving the sealing properties between the interior side of the flange part 104 and the flange cover lower part 108, and consequently, a fuel vapor, etc. do not leak between the tube attaching member 118 and the outer wall 110. The protruding linear part 102 can be composed of a single protruding linear part or a plurality of protruding linear parts.

Where a plurality of protruding linear parts 102 are provided in the interior surface of the flange part 104, the protruding linear parts 102 are welded to the parison 46 so that the interior side of the flange part 104 is bonded to the parison 46, and after the parison 46 is hardened, the sealing properties between the interior side of the flange part 104 and the flange cover lower portion 108 are improved.

As shown in FIG. 10 through FIG. 13, the protruding linear part 102 can have various sectional shapes.

First, as shown in FIG. 10, the protruding linear part 102 having a triangular sectional shape can be used. Where the sectional shape of the protruding linear part 102 is triangular, its tip end 120 is readily heated so as to be readily melted due to the parison 46 furthermore, whereby the protruding linear part 102 can be securely fusion-bonded to the parison 46. As a result, the sealing properties between the interior surface of the flange part 104 and the flange cover lower portion 108 are improved.

In the following explanations, 102(a) designates a protruding linear part on the side of a base of the flange part 104, whereas 102(b) designates a protruding linear part on the side of a tip end of the flange part 104.

In FIG. 10, a tip end 120(a) of the protruding linear part 102(a) has a wider angle to enlarge a contacting area with the parison 46, whereas a tip end 120(b) of the protruding linear part 102(b) has a narrower angle so that the protruding linear part 102(b) readily advances into the parison 46.

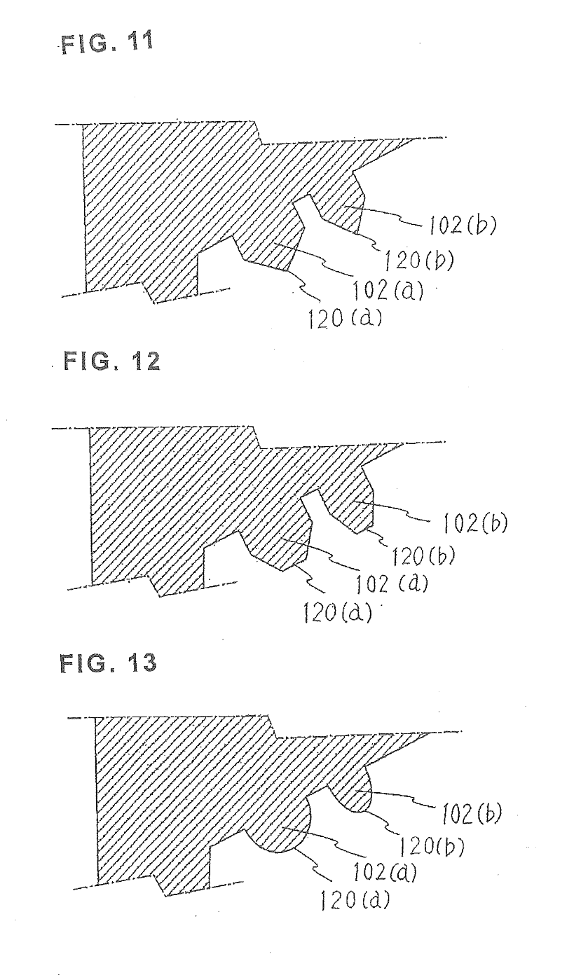

Next, as shown in FIG. 11, the protruding linear part 102 having a rectangular sectional shape in its base and a triangular sectional shape in its tip end can be used. Where the sectional shape of the tip end of the protruding linear part 102 is triangular, its tip end 120 is readily heated so as to be readily melted due to the parison 46 furthermore, similarly to the protruding linear part shown in FIG. 10, whereby the protruding linear part 102 can be securely fusion-bonded to the parison 46. As a result, the sealing properties between the interior surface of the flange part 104 and the flange cover lower portion 108 are improved. In FIG. 11, a tip end 120(a) of the protruding linear part 102(a) has a wider angle to enlarge a contacting area with the parison 46, whereas a tip end 120(b) of the protruding linear part 102(b) has a narrower angle so that the protruding linear part 102(b) readily advances into the parison 46.

And, as shown in FIG. 12, the protruding linear part 102 including a base having a rectangular sectional shape and a tip end having a trapezoidal sectional shape can be used. Where the sectional shape of the tip end of the protruding linear part 102 is trapezoidal, its tip end 120 having a trapezoidal section is melted with the parison 46 to increase an area of the protruding linear part 102 adapted to be fusion-bonded to the parison 46, whereby the protruding linear part 102 and the parison 46 are strongly fusion-bonded to each other. A tip end 120(a) of the protruding linear part 102(a) has a wider area, namely a wider contacting area with the parison 46, as compared with a tip end 120(b) of the protruding linear part 102(b), whereas a tip end 120(b) of the protruding linear part 102(b) has a narrower area, as compared with the tip end 120(a) of the protruding linear part 102(a) so that the tip end 120(b) readily advances into the parison 46.

And, where, as shown in FIG. 13, the protruding linear part 102 includes a tip end 120 having a circular or elliptical sectional shape, the tip end 120 of the protruding linear part 102, which has a circular or elliptical sectional shape, is melted with the parison 46, and advances into the parison 46 so that the protruding linear part 102 is strongly fusion-bonded to the parison 46. In FIG. 13, a tip end 120(a) of the protruding linear part 102(a), which has a circular arc with a greater diameter than that of a tip end 120(b) of a protruding linear part 102(b), has a greater contacting area with the parison 46, whereas the tip end 120(b) of the protruding linear part 102(b), which has a circular arc with a diameter less than that of the tip end 120(a) of the protruding linear part 102(a), readily advances into the parison 46.

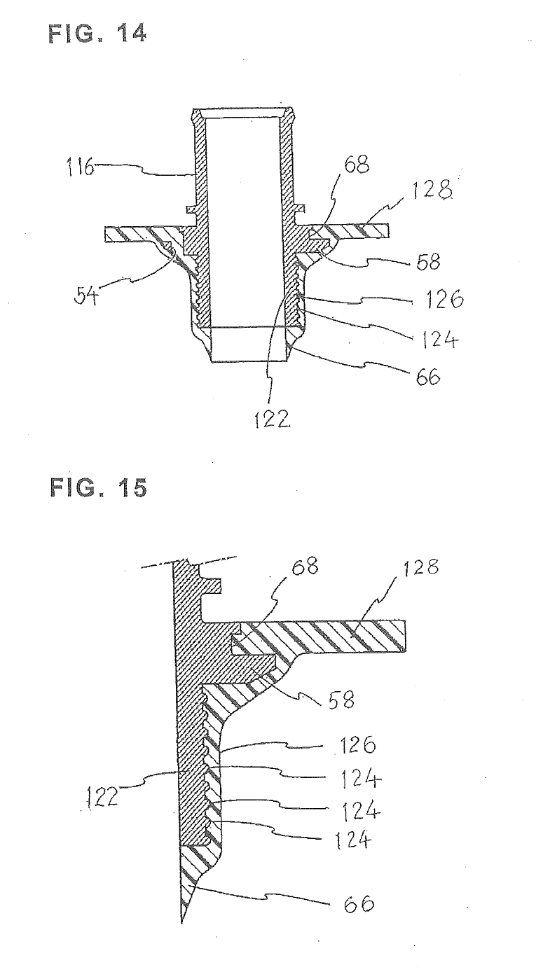

Next, a sixth embodiment will be explained with reference to FIG. 14 and FIG. 15. The sixth embodiment differs form the fifth embodiment in that a plurality of protruding linear parts are provided in an exterior surface of a tank inside cylinder part 122. The remaining portions of the sixth embodiment are identical to those of the fifth embodiment so that only different portions will be explained while omitting explanations of identical portions.

In the sixth embodiment, protruding linear parts 124 are provided in an exterior surface of the tank inside cylinder part 122. As shown in FIG. 14, a plurality of protruding linear parts 124 are provided in the exterior surface of the tank inside cylinder part 120 circumferentially. Tip ends of the protruding linear parts 124 are melted with the parison 46, and fusion-bonded thereto during blow molding. After the parison 46 is hardened, the sealing properties between an inside cylinder cover part 126 extending from a tank outer wall 128 and the protruding linear part 124 provided around the tank inside cylinder 122 are improved.

The protruding linear parts 124 may have sectional shapes equal to those shown in FIG. 10 through FIG. 13, each respectively showing the fifth embodiment.

And the protruding linear parts 124 may be provided at many places from a base to a tip end of the inside cylinder part 122, or around only the base, the tip end or about a center thereof. Alternatively, a single protruding linear part 124 may be provided.

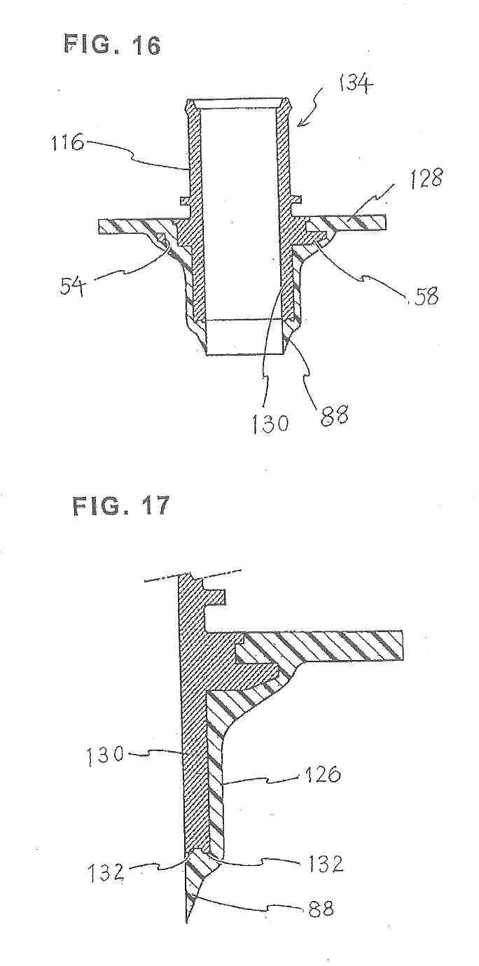

Next, a seventh embodiment will be explained with reference to FIG. 16 and FIG. 17. The seventh embodiment differs form the fifth embodiment in that a plurality of protruding linear parts are provided in a tip surface of a tank inside cylinder part 130. The remaining portions of the seventh embodiment are identical to those of the fifth embodiment so that only different portions will be explained while omitting explanations of identical portions.

In the seventh embodiment, protruding linear parts 132 are provided in a tip surface of a tank inside cylinder part 130. As shown in FIG. 17, two protruding linear parts 132 are provided in the tip surface of the tank inside cylinder part 130 circumferentially. Tip ends of the protruding linear parts 132 are melted with the parison 46 during blow molding so that the cover end 88 is welded to the parison 46 by virtue of the protruding linear parts 132. As a result, the parison 46 is readily held with the tip end of the tank inside cylinder part 130, and after the parison 46 is hardened, the cover end 88 and the tip end of the inside cylinder part 130 are welded to each other. Consequently, a tube attaching member 26 can be held strongly.

The protruding linear parts 132 may have sectional shapes similar to those shown in FIG. 10 through FIG. 13, each showing the fifth embodiment.

And, as shown in FIG. 17, two protruding linear parts 132 may be provided in the tip surface of the inside cylinder part 130. Alternatively, a single or at least three protruding linear parts 132 may be provided therein.

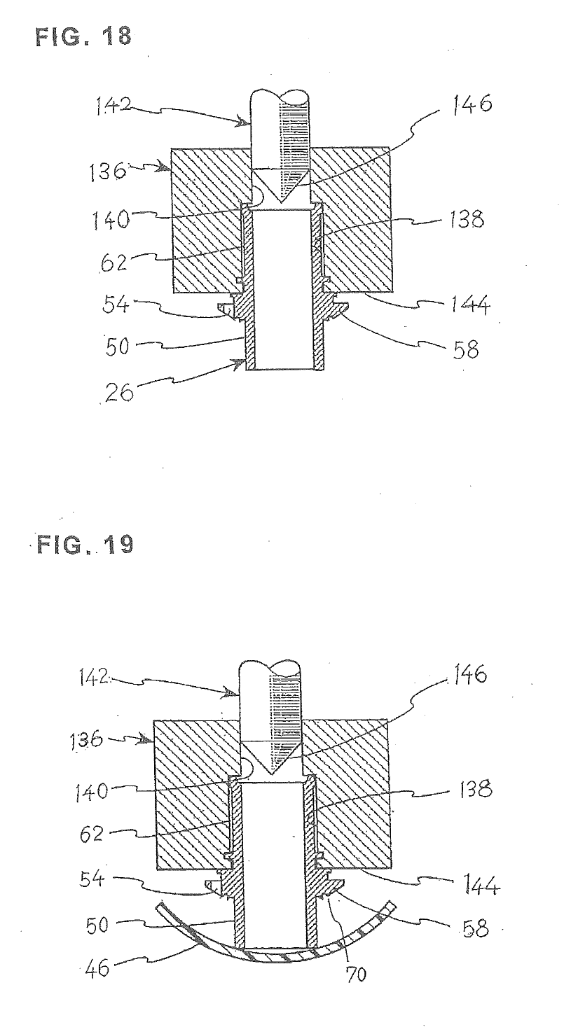

Next, the method of attaching the tube attaching member 24 as an insert member to the outer wall 28 of a fuel tank as a blow-molded article will be explained with reference to FIG. 18 through FIG. 21.

In order to attach the tube attaching member 26 to the outer wall 28 of the fuel tank, it is attached using a blow mold 136 when the fuel tank is formed by blow molding.

The blow mold 136 has a recessed part 138 adapted to fit the tank outside cylinder 62 of the tube attaching member 26. And a through hole 140 for slidably inserting a later-described blow pin 142 is provided at a bottom of the recessed part 138. The inside diameter of the tank outside cylinder 62 and that of the through hole 140 are formed equal to each other such that when the tank outside cylinder part 62 is fitted into the recessed part 138, the blow pin 142 can slide therein.

In order to attach the tube attaching member 26 to the outer wall 28, the tube attaching member 26 is first fitted into the recessed part 138 provided in an area adapted to form the opening 34 of the fuel tank 24. As a result, as shown in FIG. 18, the flange part 58 and the tank inside cylinder part 50 of the tube attaching member 26 is attached so as to project from a cavity surface 144 of the blow mold 136 into a cavity thereof.

Next, as shown in FIG. 19, the parison 46 adapted to form the outer wall 28 of the fuel tank 24 is fed into the blow mold 136. At this time, since the tank inside cylinder part 50 of the tube attaching member 26 projects into the cavity, it contacts a surface of the parison 46, but the parison 46 does not contact the cavity surface 144 of the blow mold 136.

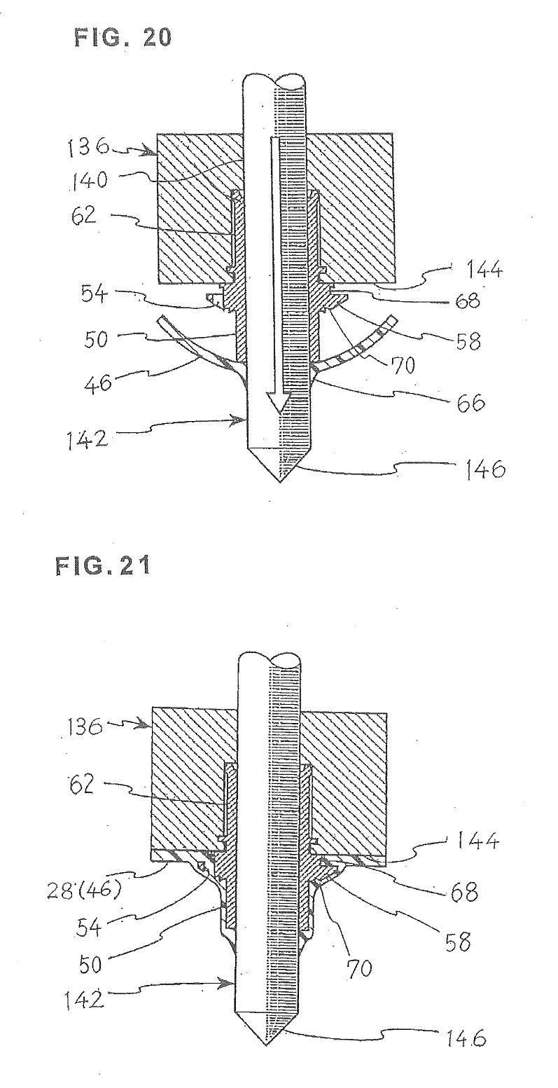

Then, as shown in FIG. 20, the blow pin 142 slides inside the through hole 140 and the tank inside cylinder part 50, and a tip end 146 of the blow pin 140 breaks through the parison 46. As a result, a through hole having a diameter equal to that of the tank inside cylinder part 50 is formed in the parison 46, and the parison 46 is fusion-bonded to the tip end of the tank inside cylinder part 50. Consequently, the cup end part 66 is formed around a tip end of the tank inside cylinder part 50 so that the cover end part 66 and the tip end of the tank inside cylinder part 50 are welded to each other.

Then, air is blown into an interior of the parison 46 without sliding the blow pin 142. As a result, the parison 46 is pressed against the cavity surface 144 of the blow mold 136 to form the outer wall 28 of the fuel tank 24. At this time, the parison 46 is in a molten state to melt the protruding linear parts 70 of the flange part 58 to fusion-bond the parison 46 thereto.

The parison 46 fusion-bonded to the flange part 58 flow through the flange holes 54 provided in the flange part 58 to reach the exterior surface of the flange part 58, and fill the recessed part 68 provided in the exterior side of the flange part 58. As a result, the entire portion of the flange part 58 can be covered with the parison 46.

After blow molding, the blow pin 142 slides inside the tank inside cylinder part 50 and the tank outside cylinder part 62 to move backwards to the through hole 140 of the blow mold 136.

As a result, in the outer wall 28 formed by hardening of the parison 46, the exterior and interior surfaces of the flange part 53 are covered with the parison 46 so as to be joined with the flange holes 54, thereby strongly holding the tube attaching member 26.

Next, the produced fuel tank 24 is removed from the blow mold 136 to finish blow molding.

With the above-described method, the tube attaching member 26 can be attached to the outer wall 28 of the fuel tank 24 simultaneously with blow molding of the fuel tank 24.

While the invention has been described in connection with what are considered to be the preferred embodiments, it is to be understood that the invention is not limited to the disclosed embodiments, but, on the contrary, is intended to cover various modifications and equivalent arrangements included within the spirit and scope of the appended claims.

What is claimed is:

1. An attaching structure of an insert member for attaching the insert member to an outer wall of a blow molded article by embedding at least one part of the insert member therein, wherein the insert member includes a cylinder part adapted to penetrate the outer wall of the blow molded article, and a flange part protruding from an exterior surface of said cylinder part in a width direction thereof, said flange part is embedded in the outer wall of the blow molded article, and includes a plurality of through holes, a parison is flowed into said plurality of through holes during blow molding to fusion-bond both surfaces of said flange part with said parison such that the parison is hardened to define a flange cover part integrally formed with an outer wall of the insert member, thereby holding said flange part.

2. The attaching structure as claimed in claim 1, wherein said plurality of through holes are provided in said flange part at equal intervals circumferentially.

3. The attaching structure as claimed in claim 1, wherein said plurality of through holes are formed to have one of an elliptical shape and a circular shape.

4. The attaching structure as claimed in claim 1, wherein said cylinder part includes an outside cylinder part projecting outside the blow molded article, and an inside cylinder part projecting inside the blow molded article, and an inside cylinder cover part is fusion-bonded to an exterior surface of said inside cylinder part.

5. The attaching structure as claimed in claim 4, wherein protruding linear parts are provided in one of said flange part and said inside cylinder part, and at least a tip end of each protruding linear part is fusion-bonded to one of said flange cover part and said inside cylinder cover part.

6. The attaching structure as claimed in claim 5, wherein said protruding linear parts include a plurality of protruding linear parts formed in an interior surface of said flange part circumferentially, and at least a tip end of each protruding linear part is fusion-bonded to said flange cover part.

7. The attaching structure as claimed in claim 5, wherein said protruding linear parts include a plurality of protruding linear parts formed in an exterior surface of said inside cylinder part circumferentially, and at least a tip end of each protruding linear part is fusion-bonded to said inside cylinder cover part.

8. The attaching structure as claimed in claim 5, wherein said protruding linear part is formed in a tip end surface of said inside cylinder part circumferentially, and at least a tip end of each protruding linear part is fusion-bonded to a cover end part extending from said inside cylinder cover part integrally therewith and adapted to cover said tip end surface of said inside cylinder part.

9. The attaching structure as claimed in claim 5, wherein said tip end of said protruding linear part has one of a triangular sectional shape, a trapezoidal sectional shape, a circular sectional shape and an elliptical sectional shape.

10. The attaching structure as claimed in claim 1, wherein said insert member has a recessed part adapted to be charged with the parison on an exterior side of said flange part.

11. The attaching structure as claimed in claim 1, wherein said blow molded article is an automobile fuel tank, and said insert member is a tube attaching member for attaching a tube adapted to inject and discharge one of liquid and gas into and from said automobile fuel tank, to said automobile fuel tank.
